(19) United States
(12) Patent Application Publication
(10) Pub. No.: US 2002/0090083 A1
(43) Pub. Date: Jul. 11, 2002

(54) Cradle device for carrying an object in the field of view of a driver of an automobile

(76) Inventors: Alan H. Grant, Chavy Chase, MD (US); Eugene Helmetsie, Spencer, NY (US)

Correspondence Address: JACOBSON, PRICE, HOLMAN & STERN, PROFESSIONAL LIMITED LIABILITY COMPANY, 400 SEVENTH STREET, N.W., WASHINGTON, DC, 20004, US

(21) Appl. No.: 09/757,658

(22) Filed: Jan. 11, 2001

(51) Int. Cl. H04M 1/00

(52) U.S. Cl. 379/454

(57) ABSTRACT

A cellular telephone device or other appliance or object is positioned in the field of sight immediately in front of a driver of an automobile. This may be accomplished by positioning the cellular telephone device on the dashboard of the automobile in a location adjacent to the peripheral edge of an imaginary line projected from the circle of the steering wheel. The driver of an automobile would then immediately be focused on the telephone device positioned in the line of sight customarily used for driving. A forward extension of the left or right arm would encounter the telephone device being held in a position so that the dialing numbers project towards the driver and are prominently displayed and immediately accessible. The cradle or bin holding the telephone device positions the telephone device to project above the dashboard and above the instruments of the automobile and in the field of view of the road immediately ahead of the automobile. The dialing function is easily accomplished by a tactile familiarity with the telephone device while the normal field of view of the driver encompasses the telephone device during driving.

### FIELD OF THE INVENTION

The present invention relates to a cradle device for carrying an object in the field of view of a driver of an automobile so as to prevent aversion of the eyes of the driver during manipulation of a telephone device, for example.

### BACKGROUND OF THE INVENTION

When a solution is developed to meet a widespread need, or to afford a new convenience, such as the ability to communicate while on the go, a worthwhile goal is achieved. This accomplishment brings with it significant problems that were either hitherto unrecognized or underestimated. This is a prime example of “The Law of Unintended Consequences”, which is used as an argument against technological advances, wherein a problem is solved at the expense of creating a worse problem.

Well understood is that cellular telephones are means of electronic communication and are not means of physical transportion. The simultaneous time combination of these two activities creates a much-less-than-optimal concentration on the paramount requirement to drive safely. What must the driver be immediately prepared to do to prevent an accident? Good vehicle control is easier to maintain than is the perceptual process of the driver. Further, when a vehicle is being driven, unpredictable perceptual tasks will arise, and if these occur contemporaneously with telephone dialing and/or conversing, this will jeopardize safety.

To quantify to what extent visual/mental efficiency is altered by the process of driving and talking has been detailed in a study commissioned by the AAA Foundation for Traffic Safety. The conclusions of this study indicate that there are significant distractions to the visual performance of the driver that involve both non-response to highway-traffic situations and increases in the time to respond. When complex, intense conversations are being carried on, there is greater loss of visual/mental attention.

There is also an age-related influence to this phenomenon. Among drivers over the age of 50 years, these decrements are shown to be two-to-three times greater than for younger drivers. However, previous experience in usage of cellular phones by this age group, as well as for younger drivers, does not mitigate any potential adverse happenings.

Traditionally, telephones have been tools that require the use of two hands, plus the necessity of visual attention to the dialing mechanism, wherein one hand acquires the mouthpiece/receiver combination (the handset), and the other hand (with visual guidance) initiates and completes the dialing sequence (either rotary or touch-tone). The visual demand to initiate and dial puts at risk the driver, passengers, pedestrians, other vehicles, and other physical obstacles.

As an example, taking one's eyes away from the road to view the dialing mechanism of a cellular telephone, at a minimum represents a 3 to 6 second visual lapse in attention to safe driving. It is unlikely that drivers who routinely use portable phones while in transit will decelerate, pull off to the side of the road, and come to a complete stop in order to safely use this communication device. Even when a driver is paying full visual attention to driving, at a routine highway speed (60 mph) when brakes are applied, the vehicle will travel approximately 367 feet before coming to a full stop. Local city driving is equally hazardous because, although vehicle speed is slower, traffic is much heavier, with vehicles being much closer together, and there is less time to react to visual distractions.

Telephone dialing time has progressively increased because more digits have to be activated to complete the desired dialing sequence. Local calls were typically a 7-digit “string”. More recently, with the inclusion of the area code, the string is lengthened to 10 digits. Long-distance calls now require an 11 digit string, and overseas calls require a 13 to 15 digit string. When routinely called numbers are programmed into the telephone, so that abbreviated dialing numbers are substituted for the full string of dialing numbers, the dialing time may be somewhat shorter, but there is still a lapse in visual attention to driving.

The driver-user takes one hand off the wheel to access and manually manipulate the telephone, and directs his or her gaze to visually access the dialing mechanism. When preprogrammed telephone numbers are not available, the user encounters a longer time interval in which to dial a string of digits.

Some users prefer to manipulate the dialing sequence with the same hand that is holding the handset. In this situation, what usually happens is that the thumb is used to access each digit. For the thumb (which is shorter and, because of the relative massiveness of its two joints, has less motility than the fingers) to sequentially activate the appropriate string of digits is cumbersome, is more visually demanding of the user and takes more time to execute. Categorically good tool usage of any kind requires total tactile familiarity (TTF) with the tool. When TTF does not exist, the tool must literally be visualized to ensure its proper usage.

Also disadvantageous to the attention of the driver is dysmetria, which is the visual undershooting or overshooting of the exact position of visual fixation on the desired target (in this case, the dialing mechanism). In shifting visual gaze from the road to a small precision telephone dial, the eyes almost always initially miss the target, and a secondary or even tertiary fixation is needed to accurately focus on the dialing mechanism.

Further, the greater the angular difference between straight-ahead viewing of the road ahead and the location of the telephone, the greater will be the dysmetric effect. (Hands-free telephones usually are located significantly below the windshield, with a larger angular difference of 40 to 70 degrees.) Each of these successive fixations expends more time, and therefore extends the time-lapse of visual attention to the primary mandate while a vehicle is being operated (safe defensive driving). This is akin to the demands encountered by computer users to make successive large-angle visual fixations between the screen and the keyboard.

Modern telephony, however beneficial and important to human communication, has come into conflict with adequate visual precepts that are essential to attentive safe driving. The wireless cellular telephone is rapidly becoming an ubiquity, with a prediction of 36 to 40 million users by the end of the year 2000, and 25 million of these are talking while driving. And even though they may possess a zero blood-alcohol level, in one sense these drivers are somewhat “intoxicated” by the freedom to conduct business while traveling.

### SUMMARY OF THE INVENTION

Accordingly, it is an object of the present invention to position a cellular telephone device or other appliance or object in the field of sight immediately in front of a driver of an automobile. This may be accomplished by positioning the cellular telephone device on the dashboard of the automobile in a location adjacent to the peripheral edge of an imaginary line projected from the circle of the steering wheel.

The driver of an automobile would then immediately be focused on the telephone device positioned in the line of sight customarily used for driving. A forward extension of the left or right arm would encounter the telephone device being held in a position so that the dialing numbers project towards the driver and are prominently displayed and immediately accessible. The cradle or bin holding the telephone device positions the telephone device to project above the dashboard and above the instruments of the automobile and in the field of view of the road immediately ahead of the automobile. The dialing function is easily accomplished by a tactile familiarity with the telephone device while the normal field of view of the driver encompasses the telephone device during driving.

The telephone device is held in a substantially vertical orientation in a bin portion, offset, if necessary, at an angle from an anchor portion attached to the dashboard, depending upon the particular type of dashboard of an automobile on which the cradle device is to be attached. Accordingly, it is possible for the bin portion of the cradle device to be tilted at any angle from the dashboard depending upon the particular type of dashboard to which the cradle device is to be attached.

Projecting rearwardly from the bin portion is the anchor portion for securing the cradle device to a dashboard. The anchor portion may include one part of a hook and loop fastener whereas the other part of the hook and loop fastener may be attached to the dashboard of the automobile by a self adhesive strip. Alternatively, the anchor portion is directly secured to the dashboard of the automobile.

The anchor portion may be made of one or two pieces. In the two piece version of the anchor portion, a rearwardly projecting member which is attached to the dashboard of an automobile, is pivotally connected about a horizontal axis to a vertically extending member holding the bin portion. The bin portion may be pivotally mounted to the vertically extending member of the two part anchor portion.

In the embodiment where the anchor portion is of an integral construction, a living hinge is formed between the rearwardly extending member and the vertically extending member of the anchor portion. The living hinge provides for flexing of the rearwardly extending member with respect to the vertically extending member so as to make the anchor portion adaptable to different angular dashboards, while maintaining the vertical plane orientation of the vertically extending member.

In either of the one or two piece constructions of the anchor portion, the bin portion may be rotatably mounted on the vertically extending member of the anchor portion. This may be accomplished by capturing one part of a rivet within the vertically extending member, the other part of the rivet being captured in the bin portion. The bin portion is rotatably secured to the vertically extending portion by the opposite end of the rivet.

A projection extending from the rear of the bin portion fits within one of a series of detents formed in the vertically extending member so as to lock the bin portion in position with an audible “click”. The bin portion would thereby be rotatable about a horizontal axis over a range of approximately 80 degrees, 40 degrees on either side of a vertical axis.

In another embodiment, including a two piece construction of the bin portion and the anchor portion, a socket joint is formed between the bin portion and the anchor portion so as to allow rotation of the bin portion with respect to the anchor portion. The anchor portion also includes a plurality of transverse recesses on opposite sides of the anchor portion so as to incorporate a flexibility to the anchor portion, accommodating different angular formed dashboards. This allows an accommodation in the anchor portion to fit any type of dashboard.

The rotation between the bin portion and the anchor portion is facilitated by at least one ball bearing engagable in respective depressions in one part of the socket connection, between the bin portion and the anchor portion. The ball bearings lock the bin portion in one of a plurality of positions.

At the bottom of the bin portion may be an electrical connection for engaging with a contact plate located at the bottom of the telephone device. The telephone device may thereby be either powered by connection to a cigarette lighter of the automobile or other power source. Alternatively a connection is made with a hands free microphone for conducting telephone conversations without the need to hold the telephone device.

Alternatively, the bin portion may be used to hold other objects in which it will be advantageous to align the item in the field of view of the driver of an automobile. For example, note-pads, eye glasses, personal electronic devices, coffee or soda cups may be positioned such that the driver's vision remains focused on the driving field of view while simultaneously accessing the object.

In addition, the cradle device of the present invention may be used in combination with a dashboard of an airplane or for such nonmobile objects such as on furniture or computer monitors. Therefore, any type of angled surface may be accommodated to position a device held within the bin portion of the cradle device of the present invention.

Accordingly, it is another object of the present invention to position a device in a field of view of an automobile driver so as to access the device without averting the eyes of a driver from the driver's field of view.

It is another object of the present invention to provide a cradle device to be mounted on a dashboard of an automobile and to accommodate all types of dashboards by a relative positioning of an anchor portion of the cradle device, with respect to a bin portion of the cradle device.

It is still yet another object of the present invention to provide a cradle device to be mounted on a dashboard of an automobile and to accommodate all types of dashboards by a relative positioning of an anchor portion of the cradle device with respect to a bin portion of the cradle device, with the bin portion being rotatable with respect to the anchor portion so as to fit any angles of the dashboard to which the cradle device is attached.

It is still yet a further object of the present invention to position a cradle device in the field of view of a driver such as to position a device to be accessed by the driver with minimal aversion of the eyes of the driver so as to focus attention of the driver on the environment surrounding the automobile.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is a schematic illustration of the preferred positioning of the cradle device of the present invention mounted on the dashboard of an automobile in the immediate field of view of the driver so that the object held by the cradle device can be focused upon without averting the eyes of the driver from their field of view.

FIG. 2 is a front view of a bin portion of one form of the cradle device of the present invention.

FIG. 3 is a cross-sectional view taken along line 3-3 of FIG. 2 and illustrating a one piece anchor portion having a vertically extending member and an integral rearwardly extending member with the rearwardly extending member pivotably connected to the vertically extending member and having a hook and loop fastener for securing the rearwardly extending member to the dashboard of an automobile.

FIG. 4 is a partial section top plan view of the cradle device shown in FIGS. 2 and 3 and illustrating the rotatable interconnection between the bin portion and the vertically extending member of the anchor portion.

FIG. 5 is a front view of an alternate embodiment of a cradle device.

FIG. 6 is a cross-sectional view taken along lines 6-6 of FIG. 5 and illustrating the two piece construction of an anchor portion with the rearwardly extending member pivotably mounted on the vertically extending member by a horizontally extending pivot pin.

FIG. 7 is a partial section top plan view of the cradle device shown in FIGS. 5 and 6 and illustrating the rotatable interconnection between the bin portion and the vertically extending member of the anchor portion.

FIG. 8 is a perspective view of an alternate, preferred embodiment of the cradle device of the present invention illustrating an anchor portion formed of a rearwardly extending member having one part of a ball and socket connection engaging the other portion of the ball and socket connection mounted on a rear side of the bin portion so as to provide a relative rotatability of the bin portion with respect to the anchor portion.

FIG. 9 is a rear perspective view of the cradle device shown in FIG. 8 and illustrating three ball bearings interposed between the two parts of the ball and socket connection of the anchor portion and the bin portion for locking the position of the bin portion after being rotated to a desired position.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

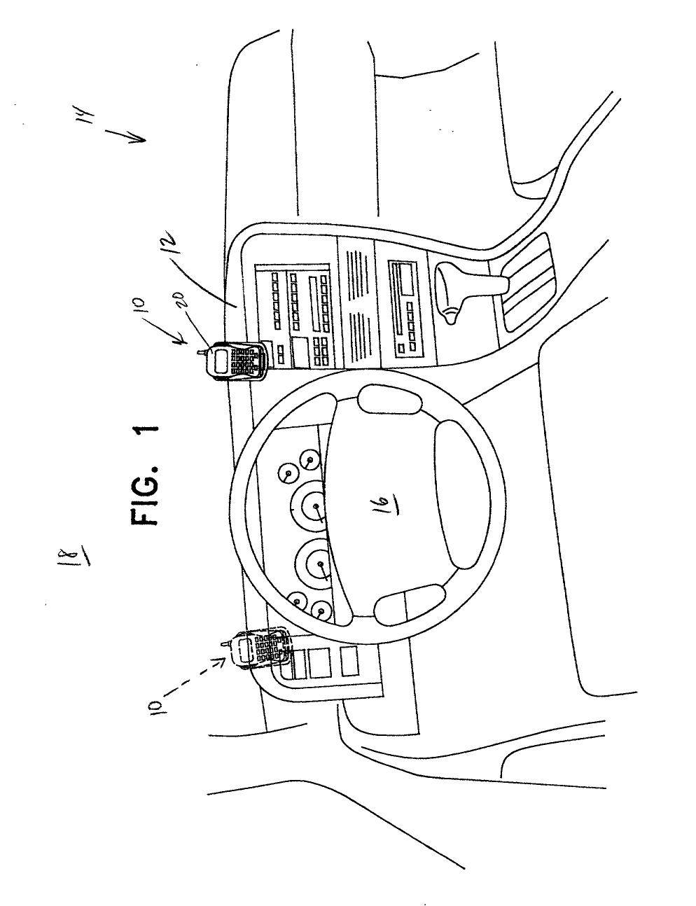

With reference to the drawings, in general, and to FIG. 1, in particular, a cradle device for carrying an object in the field of view of the driver of an automobile embodying the teachings of the subject invention is generally designated as 10. With reference to is orientation in FIG. 1, the cradle device 10 is shown in solid lines mounted on a dashboard 12 of an automobile 14, to the right side of a steering wheel 16. Alternatively, the cradle device 10 may be mounted on the left side of the steering wheel 16 as is shown in dotted lines. The critical feature is that the cradle device is mounted in the field of view 18 of an operator driving an automobile.

In FIG. 1, the cradle device 10 is holding a cellular telephone device 20 for exemplary purposes. It is understood as being within the scope of the present invention that other objects may be held in the cradle device where it is desirous that the eyes of the operator of the automobile are not adverted from the field of view 18 during the driving operation. Advantageously, the cradle device 10 is mounted so that the arms of the operator of an automobile may be extended in a horizontal plane so as to engage the cradle device and its contents.

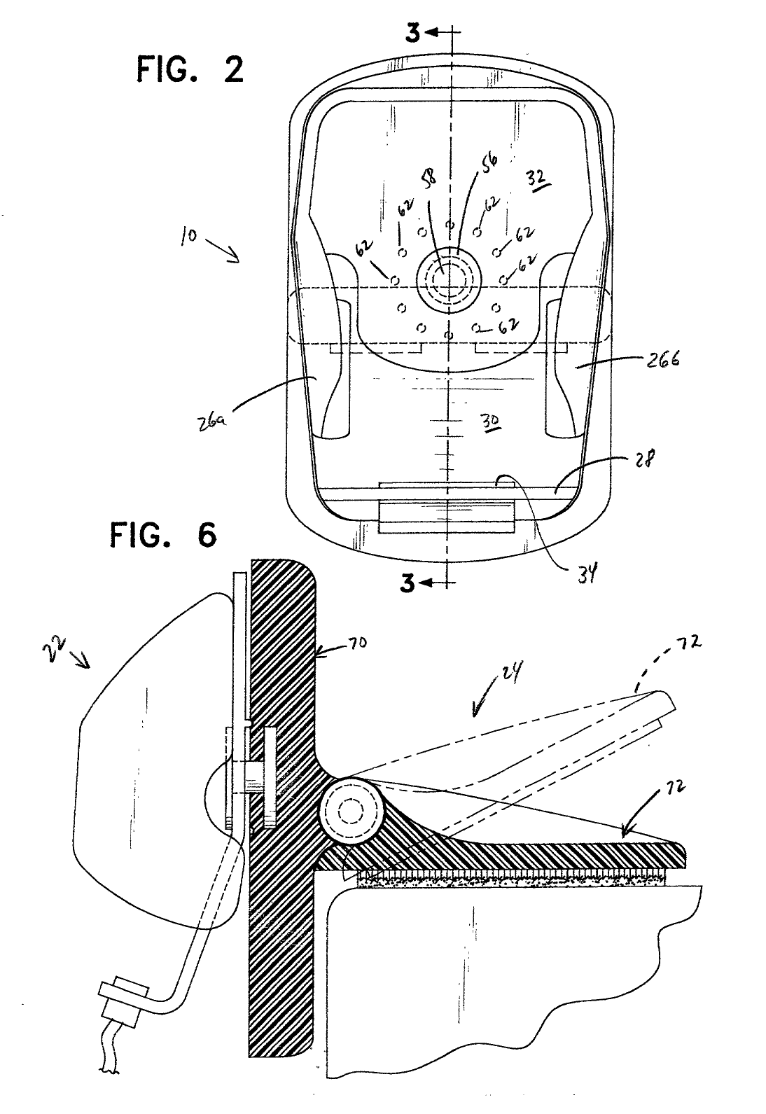

In one embodiment of the cradle device of the present invention, as shown in FIGS. 2 through 4, the cradle device 10 includes a bin portion 22 and an anchor portion 24. The bin portion includes two arms 26a, 26b located on opposite sides of the bin portion 22 so as to hold the lateral side edges of an object. A bottom plate 28 supports the bottom of the object. An angled extension plate 30 interconnects the bottom plate 28 with the rear support plate 32 forming the rear wall of the bin portion.

The bottom plate optionally includes an electrical contact plate 34 for engagement with the electrical contacts of a cellular telephone device when such device is mounted in the bin portion 22. An electrical cord 36 may be connected to a power source, such as a cigarette lighter for charging the telephone device. Alternatively, the cord 36 may be a connection to a microphone or a speaker for a hands free operation of the telephone device.

In the embodiment of FIGS. 2 through 4, the anchor portion 24 is of a one piece construction. The anchor portion 24 includes a vertically extending member 38 and a horizontal, rearwardly extending member 40. Interconnecting the members 38 and 40 is a living hinge portion 42 which provides a flexibility between the two members.

On the bottom surface 44 of the rearwardly extending member 40 is located one piece 46 of a two piece hook and loop fastener. The other piece 48 is secured to an upper surface 50 of dashboard 12. Two hook and loop fastener strips may be used to secure the rearwardly extending member 40 to the dashboard 12 as shown in FIG. 4.

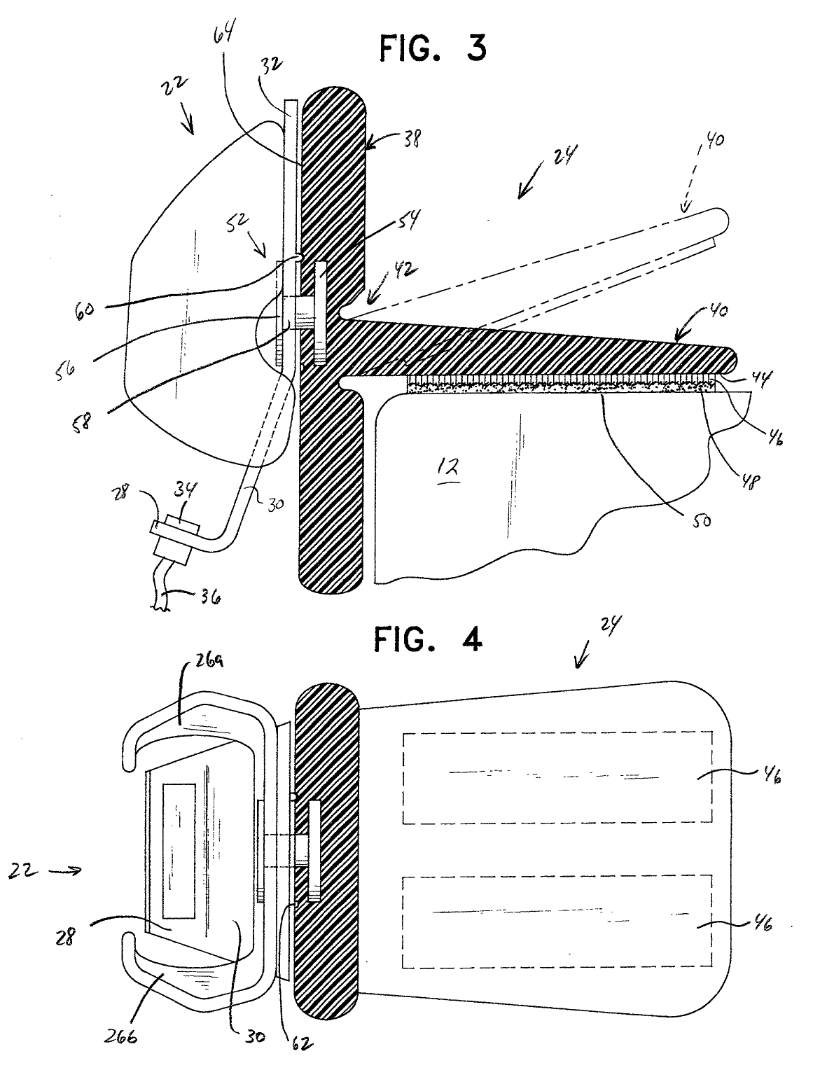

Depending upon the angular surfaces of the dashboard 12, the rearwardly projecting member 40 may be moved into alternate positions as shown in dotted lines in FIG. 3 so as to accommodate a positioning of the cradle device on any dashboard. Despite the movement of the rearwardly extending member 40, member 38 is maintained in a vertical plane orientation by living hinge 42.

While member 38 may be positioned in a relative vertical plane, it is desirable to position the bin portion 22 in a vertical orientation in the line of sight of a driver of an automobile. Accordingly, a rotatable interconnection between the bin portion 22 and anchor portion 24 is, in this embodiment, accommodated by a rivet 52 having one end 54 anchored within vertical extending member 38. The opposite end 56 of the rivet 52 is secured to the bin portion 22. The ends 54, 56 of the rivet 52 are interconnected by a shaft 58.

Projecting from rear support plate 32 of the bin portion 22 is pin 60. Pin 60 is movable with the bin portion 22 until engaging in one of a plurality of recesses 62 arranged in a circle on the front surface 64 of member 38. The interconnection of the bin portion 22 and anchor portion 24 by the rivet 52 biases the pin 60 to fit into one of the recesses 62 and hold the bin portion fixed relative to member 38. Therefore, no matter what type of angular surface is presented by a dashboard of different automobiles, it is always possible to maintain the bin portion and the object it is holding in a vertical orientation in front of the driver of an automobile.

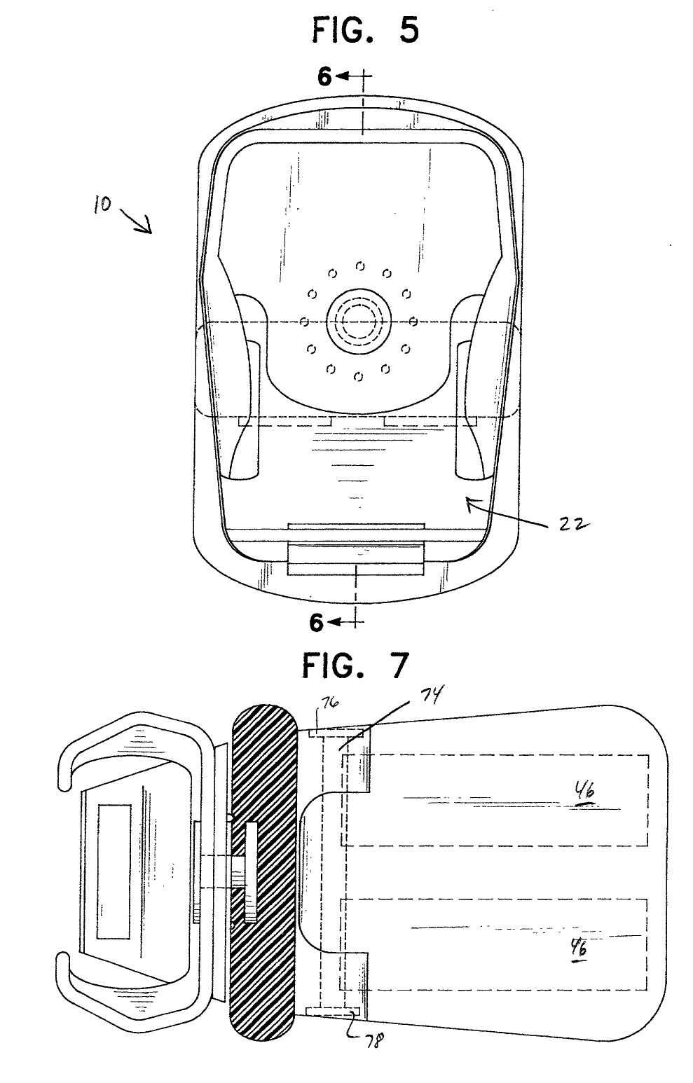

In FIGS. 5 through 7, similar reference numerals are used as were used in the description of FIGS. 2 through 4. However, in FIGS. 5 through 7, the anchor portion 24 is of a two piece construction, including vertical extending member 70 and rearwardly extending member 72. In this embodiment, the members 70, 72 are interconnected by a pivot pin 74 so as to allow the alternate positioning of the member 70 with respect to member 72 as is shown in dotted lines in FIG. 6. Opposite ends of the pin include flanges 76, 78 to secure the members 70, 72 to each other and allow their relative movements.

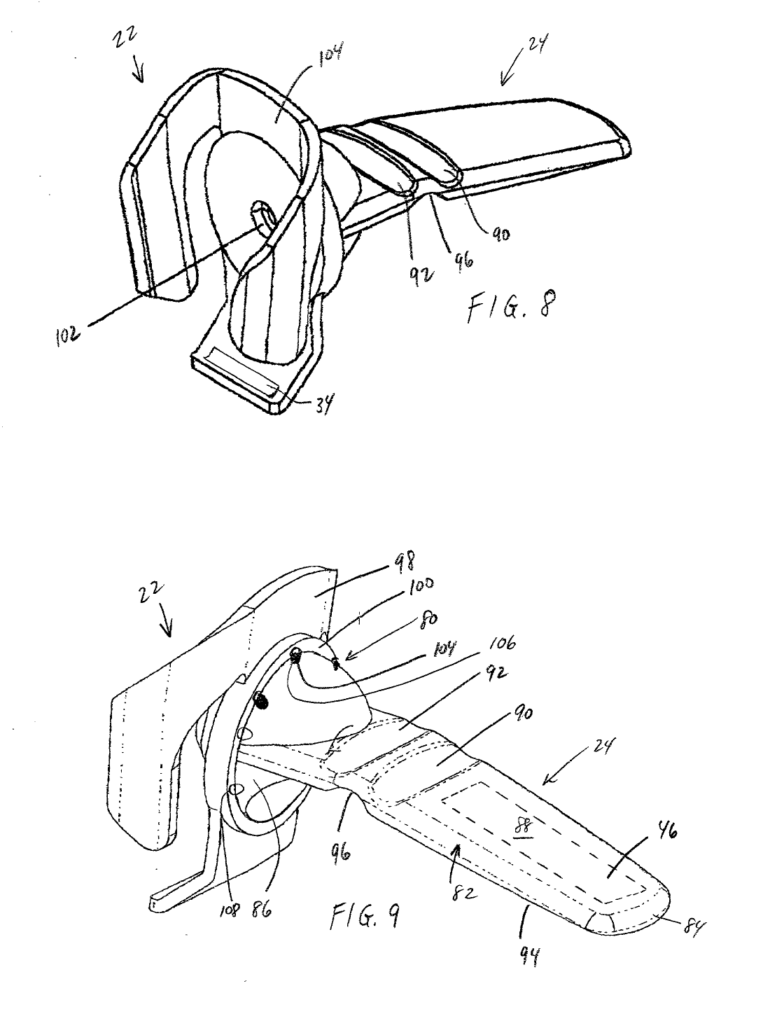

In the preferred embodiment shown in FIGS. 8 and 9, the bin portion 22 is interconnected to the anchor portion 24 by a ball and socket connection 80. Anchor portion 24 includes a rearwardly extending member 82 having a free end 84 and an opposite end 86 forming the ball portion of the ball and socket connection 80.

On an upper surface 88 of the anchor portion 24 are located two transverse groves 90, 92. Located between the two At grooves 90, 92 on the bottom surface 94 of the anchor portion 24 is located a single transverse groove 96. The sequential spacing of the grooves 90, 92, 96 provides flexibility between the free end 84 of the anchor portion and the end 86 terminating in the ball of the ball and socket connection 80.

In a rear surface 98 of the bin portion is formed a socket 100 of the ball and socket connection 80. The end 86 of the anchor portion 24 fits within the socket 100 for a relative rotatability of the bin portion 22 with respect to the anchor portion 24. Rotatably securing the bin portion to the anchor portion is a screw or bolt 102 extending from a front surface 104 of the bin portion, rearwardly into the anchor portion.

To maintain the positioning of the bin portion 22 with respect to the anchor portion 24, a ball bearing 104 may be positioned in one of more of the recesses 106 formed in the ball portion 86 of the ball socket connection 80. A plurality of corresponding recesses 108 in the socket portion 100 provide for a locking of the ball portion with respect to the socket portion when a ball bearing is positioned in both a recess 106 and a recess 108. This locks the relative alignment of the bin portion with respect to the anchor portion so as to position an object held within the bin portion in a vertical orientation, preferably in the field of view of an operator of an automobile.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

We claim:

1. A cradle device for holding an object in a vertical orientation, said cradle device comprising:
an anchor portion, said anchor portion being flexible to accommodate mounting on different angled surfaces, and a bin portion for holding the object in a vertical orientation, said bin portion being rotatably mounted on said anchor portion.

2. A cradle device as claimed in claim 1, wherein said anchor portion is a single piece having two members pivotally mounted with respect to each other.

3. A cradle device as claimed in claim 1, wherein said anchor portion is of a two piece construction, having two members pivotally mounted with respect to each other.

4. A cradle device as claimed in claim 1, wherein said anchor portion and said bin portion are interconnected by a ball and socket connection.

5. A cradle device as claimed in claim 4, wherein said anchor portion and said bin portion are lockable in a position with respect to each other.

6. A cradle device as claimed in claim 5, wherein said anchor portion includes at least one groove in each of an upper surface and a lower surface.

7. A cradle device as claimed in claim 6, wherein the lower surface of said anchor portion includes at least one two-part strip for mounting said anchor portion on an angled surface.

8. A cradle device as claimed in claim 2, wherein said bin portion includes an electrical contact plate.

9. A cradle device as claimed in claim 3, wherein said bin portion includes an electrical contact plate.

10. A cradle device as claimed in claim 4, wherein said bin portion includes an electrical contact plate.

11. A cradle device for holding a telephone device in a vertical orientation on a dashboard of an automobile in the forward field of view of a driver of the automobile, said cradle device comprising:
an anchor portion, said anchor portion being positionable on any surface of the dashboard to the left or right of a steering wheel at an elevation in the forward field of view of the driver of the automobile, and
a bin portion for holding the telephone device in a vertical orientation, said bin portion being rotatably mounted on said anchor portion for positioning the telephone device at a desired angular orientation immediately in front of the driver so as to conveniently locate the buttons of the telephone device in the immediate forward reach of the driver.

12. A cradle device as claimed in claim 11, wherein said anchor portion is a single piece having two members pivotally mounted with respect to each other.

13. A cradle device as claimed in claim 11, wherein said anchor portion is of a two piece construction, having two members pivotally mounted with respect to each other.

14. A cradle device as claimed in claim 11, wherein said anchor portion and said bin portion are interconnected by a ball and socket connection.

15. A cradle device as claimed in claim 14, wherein said anchor portion and said bin portion are lockable in a position with respect to each other.

16. A cradle device as claimed in claim 15, wherein said anchor portion includes at least one groove in each of an upper surface and a lower surface.

17. A cradle device as claimed in claim 16, wherein the lower surface of said anchor portion includes at least one two-part strip for mounting said anchor portion on an angled surface.

18. A cradle device as claimed in claim 12, wherein said bin portion includes an electrical contact plate.

19. A cradle device as claimed in claim 13, wherein said bin portion includes an electrical contact plate.

20. A cradle device as claimed in claim 14, wherein said bin portion includes an electrical contact plate.
